(19) United States
(12) Patent Application Publication
(10) Pub. No.: US 2007/0286961 A1
(43) Pub. Date: Dec. 13, 2007

(54) Wear-resistant brake disc or brake drum and method for producing same

(75) Inventors: Wolfgang Pahle, Bad Wiessee (DE); Suryakant Khambekar, Muenchen (DE); Johann Baumgartner, Moosburg (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 11/797,069

(22) Filed: Apr. 30, 2007

Related U.S. Application Data
(63) Continuation of application No. PCT/EP2005/010445, filed on Sep. 28, 2005.

(30) Foreign Application Priority Data
Oct. 29, 2004 (DE) 10 2004 052 673.7

(51) Int. Cl. C23C 4/06; B05D 1/08

(52) U.S. Cl. 427/449; 188/218 XL; 427/455; 427/456

(57) ABSTRACT

A brake disc or brake drum including friction surfaces, preferably for land vehicles, and a method for producing them, are provided. The brake disc or brake drum includes a base body, which is made of a cast iron material provided, completely or sectionally, with a metal spray coating on at least one of the frictional surfaces thereof in order to interact with the brake lining. The spray coating is embodied as a flame spraying, arc spraying or plasma spraying coating, or an explosion coating, and is made from a material harder than the base body, and which is more oxidation-resistant and wear-resistant than the base body. The spray coating is produced by an injection wire having a Cr content of more than 20% by weight.

### CROSS-REFERENCE TO RELATED APPLICATIONS

This application is a continuation of PCT International Application No. PCT/EP2005/010445, filed on Sep. 28, 2005, which claims priority under 35 U.S.C. §119 to German Application No. 10 2004 052 673.7, filed Oct. 29, 2004, the entire disclosures of which are expressly incorporated by reference herein.

### BACKGROUND AND SUMMARY OF THE INVENTION

The invention relates to a brake disc or a brake drum having frictional surfaces, and to a process for producing it.

Brake discs and brake drums convert the frictional power applied during braking into heat. The work of friction causes wear to the friction partners, making it necessary to replace the friction partners when a permissible wear limit is reached.

Another reason, which often forces brake discs and drums to be replaced, is changes in the flatness or roundness and associated thickness fluctuations, in particular in the case of brake discs. These changes, under certain circumstances, give rise to rubbing and booming, which leads to fluctuations in the braking torque and can, therefore, have effects on the vehicle stability and driving safety.

Changes to the surface may arise on the one hand through thermal stresses, which lead to distortion of the frictional body or partial changes in material as a result of the formation of hot spots, or through cold disc wear, i.e. in the unbraked state, the brake disc and linings keep briefly touching one another, leading to uneven wear. Even when the vehicle has been switched off, changes in the surfaces may occur as a result of corrosion to the frictional surface or rusting of the brake linings.

It has already been attempted to counteract these effects by using more wear-resistant materials, such as special gray cast iron alloys, aluminum alloys with silicon compound contents, or composite materials comprising fiber materials with incorporated ceramic materials. In these attempts, the aim has generally been to distribute the wear-reducing materials uniformly over the entire frictional body. This leads to high costs and under certain circumstances nevertheless unsatisfactory results.

Developments in which wear prevention is concentrated within just a few millimeters of the surface of the frictional surface, for example as a spray coating, entail the problem that, under high loads caused by the pairing of different materials between base body and frictional layer, stresses build up, leading to cracks, score marks and to the spray coating flaking off.

It is known from DE 100 56 161 and DE 101 20 326 to apply a chromium-containing material to a base body of gray cast iron by flame, arc or plasma spraying in the wearing region of the frictional surfaces. Since a metallic spray coating is used instead of a ceramic one, the bonding of the spray coating with respect to brake discs with ceramic coatings is optimized in a simple way. The spray coating consists of a metal which is harder than the core, in particular an unalloyed or alloyed steel.

It is preferable for the spray coating to consist of a Cr-containing steel alloy. In particular, the Cr content of the spray coating is between 10 and 20%. When using a spray coating with the Cr content indicated, the service life of the brake disc can often be doubled with a spray coating thickness of 0.7 mm. This brake disc is eminently suitable for commercial vehicles and can also be used with great success in particular for passenger automobiles, in particular in the luxury and sports sectors.

In view of this background, the invention is based on the object of optimizing the advantageous brake discs and brake drums of the above-mentioned type—as are described in principle in DE 100 56 161 and DE 101 20 326—still further.

The invention achieves this object, by providing a brake disc and a brake drum with frictional surfaces, preferably for land vehicles, wherein the brake disc or brake drum has a base body made from a cast iron material which, at least on one of its frictional surfaces for interacting with a brake lining, is provided completely or in sections with a metallic spray coating. The spray coating is in the form of a flame, arc or plasma spray coating or an explosion coating and is made of a metal which is harder than the base body and is also more resistant to oxidation and wear than the base body. The spray coating is realized by way of an injection wire with a Cr content of from 25 to 30% by weight. The invention further provides an advantageous process for producing the brake disc and brake drum, wherein the spray coating is realized by an injection wire made from a steel with a Cr content of more than 20% by weight, preferably with a Cr content of from 25 to 30% by weight, and in particular with a Cr content of 28% by weight.

Advantageous configurations are described herein.

According to the invention, the spray coating of the single-piece or multi-piece base body is realized by means of an injection wire with a Cr content of more than 20% by weight, since the use of injection wires of this type leads to improved corrosion resistance with properties which otherwise remain as good as before.

The use of injection or spraying wires with a chromium content of 25%-30%, preferably 28%, which leads to a particularly significant reduction in the susceptibility to corrosion while continuing to retain good wearing properties, has proven particularly suitable.

The measure of increasing the Cr content is preferably supplemented by the injection wires having a carbon content of at least 0.5%, since this leads to increased carbide formation—i.e. a high resistance to wear—without losing the absence of corrosion.

According to another inventive option, it is particularly preferable for a barrier layer, which consists of a softer metallic material than the spray coating and is preferably from 0.05 to 0.1 mm thick, to be formed between the spray coating and the base material of the base body. The barrier layer may contain molybdenum or nickel.

The barrier layer leads to a uniform and good distribution of heat, provides additional protection for the base body from corrosion in the region of the barrier layer and, on account of its ductility and lower hardness, reduces internal stresses in the spray coating.

According to another variant—which may preferably be considered optional but also independent—it is particularly preferable to carry out a heat treatment following the spraying process to reduce internal stresses and further precipitate carbides.

The combination of the measures of an increased Cr content, a softer intermediate layer, and a heat treatment has proven very particularly advantageous, leading to a substantially corrosion-resistant frictional layer, which is nevertheless also resistant to wear and flaking, for interacting with a brake lining.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a section through a first exemplary embodiment of a brake disc according to the invention; and

FIG. 2 shows a microsection through a region of a spray coating and the edge of the gray cast iron core on an enlarged scale.

### DETAILED DESCRIPTION OF THE DRAWINGS

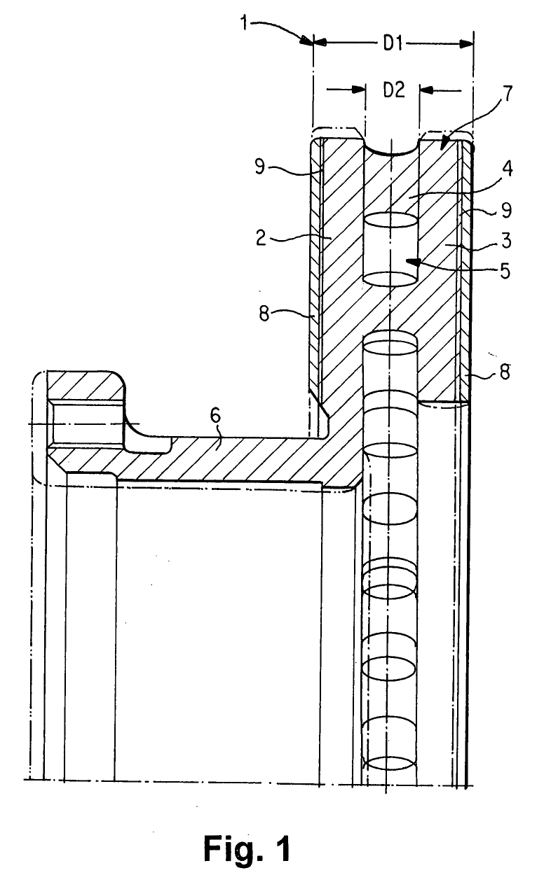

FIG. 1 shows a brake disc 1, which has two friction rings 2, 3 integrally connected to one another by webs 4. An air duct 5 is formed between the friction rings 2, 3 and the webs. A cup-like shoulder 6 for securing the brake disc to a wheel hub (not shown here) is formed on one friction ring 2.

The two friction rings 2, 3 and the webs (and in this case also the shoulder 6) together form a single-piece brake disc base body or a core 7.

A similar base body—of suitably different design—for example made from gray cast iron can be realized for a brake drum (not shown here).

In accordance with FIG. 1, the core 7 is provided, on each of its two axial outer surfaces, with a wear-resistant metallic, nonceramic spray coating 8 as the frictional surface. In accordance with FIG. 1, the entire axial outer surfaces are covered with the spray coating 8.

During braking operations, therefore, up until the point at which the spray coating 8 has been completely worn away, only this spray coating is exposed as frictional surface to the abrasion which occurs during braking operations.

Since the metallic spray coating 8 is harder than the core 7 made from gray cast iron, the service life of the brake disc is increased. However, since the majority of the volume of the brake disc, namely the core 7, consists of gray cast iron, its advantageous further properties, for example with regard to thermal conductivity and the susceptibility to cracking, are retained or even improved by the application of the spray coating 8.

Since the reduction in wear is apparently based on the formation of carbides and oxides from the chromium and other constituents of the material used in the spraying process, these constituents have to be present in a sufficient concentration.

When using an injection wire containing 17% of Cr according to the prior art, 5 to 7% are converted in the spray coating into chromium carbides and chromium oxides. At the same time, the proportion of free chromium drops to 10 to 13%, with the result that the layer, although resistant to wear, also becomes susceptible to corrosion.

The use according to the invention of injection wires with an increased Cr content of, in particular, 25 to 30% Cr, and particularly preferably 28% Cr, by contrast, makes it easy to achieve sufficient corrosion resistance to salt water.

At the same time, the formation of carbides can be considerably increased by a carbon content of at least 0.5%. However, the increased formation of carbides also increases the overall hardness of the layer and the internal stresses.

Then, under certain circumstances, during relatively strong braking operations, cracks may occur in the spray coating, which under extreme circumstances lead to the layer becoming detached. This effect can, in turn, be counteracted in a simple way by a heat treatment which is carried out after the spray coating. For example, a heat treatment at 650° C. has lead to improved results.

In the case of flat brake discs, it is also contemplated to use an induction method, in which the frictional surfaces are strongly heated and the brake discs, immediately after the heating, stacked on top of one another in a closed space, only release the temperature again very slowly.

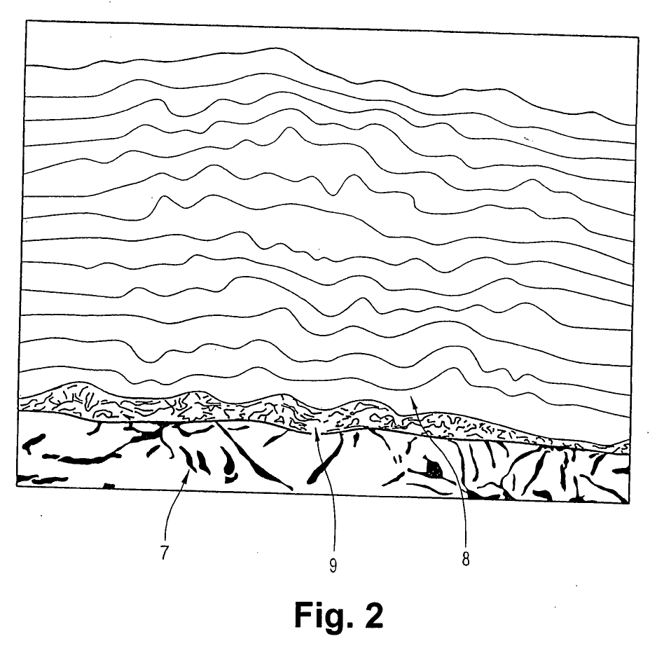

To further improve the bonding of the spray coating to the base material of the base body 7, it is advantageous to use a barrier layer 9 between wear-resistant layer 8 and base material (cf. the left-hand side of the brake disc from FIG. 1 and the lines which delimit the barrier layer in the sectional image shown in FIG. 2).

The barrier layer 9 has the purpose of uniformly distributing the heat, protecting the base material from corrosion and, by virtue of its ductility and lower hardness, reducing internal stresses in the spray coating.

Molybdenum and/or materials with a high nickel content are particularly suitable for realizing the barrier layer 9.

This barrier layer 9 is preferably likewise applied in a spraying process. The advantageous effect for a nickel-containing layer was confirmed in tests.

Stresses in the spray coating can be considerably reduced on account of the significantly lower hardness of the nickel layer (150 to 180 HV1) compared to the chromium-containing spray coating. Consequently, the frictional bodies are less susceptible to fine stress cracks.

This is also promoted by the significantly higher thermal conductivity of the nickel layer of approx. 50 W/mK compared to the chromium layer at approx. 15 W/mK. The heat which is generated during braking is absorbed more quickly by the nickel layer than would be possible with gray cast iron alone. The formation of hot spots can in this way be reduced. Furthermore, the soft barrier layer 9 prevents initial cracks, which have formed in the spray coating 8, from progressing to the base material. It therefore advantageously acts as a crack stopper.

Corrosive attack on the base material is prevented in this way and by the resistance to corrosion of the barrier layer 9 itself. The layer no longer flakes off as a result of corrosion. The barrier layer 9 is from 0.05 to 0.1 mm thick. Furthermore, axial spray coating thicknesses of from 0.3 to 1.5 mm, preferably 0.5-1.2 mm, and in particular 0.6-0.9 mm, have proven particularly suitable.

Table of Reference Numbers

Brake disc 1
Friction rings 2, 3
Webs 4
Air duct 5
Shoulder 6
Core 7
Spray coating 8
Intermediate layer 9

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake component that interacts with a brake lining, comprising:
a base body made of a cast iron material, the base body having at least one frictional surface that, in use, interacts with the brake lining;
a metallic spray coating formed by one of flame, arc, plasma, and explosion coating on the at least one frictional surface, the metallic spray coating being made of a metal which is harder than the cast iron material of the base body and more resistant to oxidation and wear than the base body; and
wherein the metallic spray coating is formed by an injection wire having a Cr content of from 25 to 30% by weight.

2. The brake component as claimed in claim 1, wherein the brake component is a brake disc or brake drum.

3. The brake component as claimed in claim 2, wherein the brake disc or brake drum is for a land vehicle.

4. The brake component as claimed in claim 1, wherein the spray coating is produced by an injection wire with a Cr content of 28% by weight.

5. The brake component as claimed in claim 1, wherein the spray coating is produced by way of an injection wire with a carbon content of at least 0.5% by weight.

6. The brake component as claimed in claim 1, further comprising a barrier layer, which is composed of a softer metallic material than the spray coating, and is formed between the spray coating and the cast iron material of the base body.

7. The brake component as claimed in claim 6, wherein a thickness of the barrier layer is from 0.05 to 0.1 mm.

8. The brake component as claimed in claim 6, wherein the barrier layer contains molybdenum.

9. The brake component as claimed in claim 7, wherein the barrier layer contains molybdenum.

10. The brake component as claimed in claim 6, wherein the barrier layer contains nickel.

11. The brake component as claimed in claim 7, wherein the barrier layer contains nickel.

12. The brake component as claimed in claim 8, wherein the barrier layer contains nickel.

13. A process for producing a brake disc or brake drum that interacts with a brake lining, the process comprising the acts of:
receiving a base body of the brake disc or the brake drum; and
spray coating a frictional surface of the base body using an injection wire having a Cr content of from 25 to 30% by weight.

14. The process as claimed in claim 13, wherein the Cr content of the injection wire is 28% by weight.

15. The process as claimed in claim 13, wherein the injection wire has a carbon content of at least 0.5% by weight.

16. The process as claimed in claim 13, further comprising the act of forming a barrier layer, composed of a softer metallic material than the spray coating, between the spray coating and a base material of the base body.

17. The process as claimed in claim 16, further comprising the act of heat treating the brake disc or brake drum following the spray coating.

18. The process as claimed in claim 17, wherein the heat treatment is performed at the coating at between 600° C. and 700° C.

19. The process as claimed in claim 17, wherein heat treatment is carried out via an induction method.

20. The process as claimed in claim 19, wherein the induction method comprises the acts of:
strongly heating frictional surfaces of the base body; and
immediately after the heating, slowly cooling the brake disc or brake drum relative to the heating act.

21. A brake component that interacts with a brake lining, comprising:
a base body made of a cast iron material, the base body having at least one frictional surface that, in use, interacts with the brake lining;
a metallic spray coating formed by one of flame, arc, plasma, and explosion coating on the at least one frictional surface, the metallic spray coating being made of a metal which is harder than the cast iron material of the base body and more resistant to oxidation and wear than the base body; and
a barrier layer composed of a softer metallic material than the spray coating, the barrier layer being formed between the spray coating and the cast iron material of the base body.

22. A process for producing a brake disc or brake drum that interacts with a brake lining, the process comprising the acts of:
receiving a base body of the brake disc or the brake drum;
spray coating a frictional surface of the base body using an injection wire with a Cr content; and
forming a barrier layer, composed of a softer metallic material than the spray coating, between the spray coating and a base material of the base body.

23. A process for producing a brake disc or brake drum that interacts with a brake lining, the process comprising the acts of:
receiving a base body of the brake disc or the brake drum;
spray coating a frictional surface of the base body using an injection wire with a Cr content; and
heat treating the brake disc or brake drum following the spray coating.
